(19) United States
(12) Patent Application Publication
(10) Pub. No.: US 2022/0237147 A1
(43) Pub. Date: Jul. 28, 2022

(54) INFORMATION PROCESSING APPARATUS, NON-TRANSITORY COMPUTER READABLE MEDIUM, AND INFORMATION PROCESSING METHOD

(71) Applicant: FUJIFILM BUSINESS INNOVATION CORP., Tokyo (JP)

(72) Inventors: Yuta NAKAMORI, Tokyo (JP); Kengo TOKUCHI, Kanagawa (JP)

(73) Assignee: FUJIFILM BUSINESS INNOVATION CORP., Tokyo (JP)

(21) Appl. No.: 17/373,059

(22) Filed: Jul. 12, 2021

(30) Foreign Application Priority Data
Jan. 28, 2021 (JP) 2021-012444

(51) Int. Cl. G06F 16/11; G06F 16/16; G06F 21/62

(52) U.S. Cl. CPC G06F 16/122; G06F 2221/2147; G06F 21/6218; G06F 16/16

(57) ABSTRACT

An information processing apparatus includes a processor configured to, when a hierarchical structure of folders is used to manage a file, prohibit creation of a folder belonging to a hierarchical level lower than a specific hierarchical level.

### CROSS-REFERENCE TO RELATED APPLICATIONS

This application is based on and claims priority under 35 USC 119 from Japanese Patent Application No. 2021-012444 filed Jan. 28, 2021.

### BACKGROUND

### (i) Technical Field

The present disclosure relates to an information processing apparatus, a non-transitory computer readable medium, and an information processing method.

### (ii) Related Art

Japanese Unexamined Patent Application Publication No. 2010-67094 describes a system which automatically generates metadata from position information of a file in a folder hierarchical structure by utilizing the fact that the position information is accurately determined by the action of saving the file, which is performed by a user routinely.

Japanese Unexamined Patent Application Publication No. 2002-215441 describes a system which records, for later use in a file search, the process of searching for a file in the case where many files and folders are managed hierarchically.

Japanese Unexamined Patent Application Publication No. 2007-279960 describes an apparatus for searching for and viewing an electronic form.

### SUMMARY

Aspects of non-limiting embodiments of the present disclosure relate to a technique for, in the case where files are managed by using a hierarchical structure of folders and a user searches for a file non-automatically, alleviating a user's operational burden of searching for a target file, compared with the case in which unlimited hierarchization of folders is permitted.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to, when a hierarchical structure of folders is used to manage a file, prohibit creation of a folder belonging to a hierarchical level lower than a specific hierarchical level.

### BRIEF DESCRIPTION OF THE DRAWINGS

Exemplary embodiments of the present disclosure will be described in detail based on the following figures, wherein:

FIG. 1 is a block diagram illustrating the configuration of an information processing apparatus according to the present exemplary embodiment;

FIG. 2 is a diagram illustrating a hierarchical structure of folders;

FIG. 3 is a diagram illustrating a hierarchical-level limit setting screen;

FIG. 4 is a diagram illustrating a folder management screen;

FIG. 5 is a diagram illustrating a hierarchical structure of folders;

FIG. 6 is a diagram illustrating a hierarchical structure of folders;

FIG. 7 is a diagram illustrating a hierarchical structure of folders;

FIG. 8 is a diagram illustrating a hierarchical-level limit setting screen;

FIG. 9 is a diagram illustrating a hierarchical-level limit setting screen;

FIG. 10 is a diagram illustrating a hierarchical-level limit setting screen;

FIG. 11 is a diagram illustrating a hierarchical structure of folders;

FIG. 12 is a diagram illustrating a hierarchical-level limit setting screen;

FIG. 13 is a diagram illustrating a setting screen for searching; and

FIG. 14 is a diagram illustrating the playback order of movies.

### DETAILED DESCRIPTION

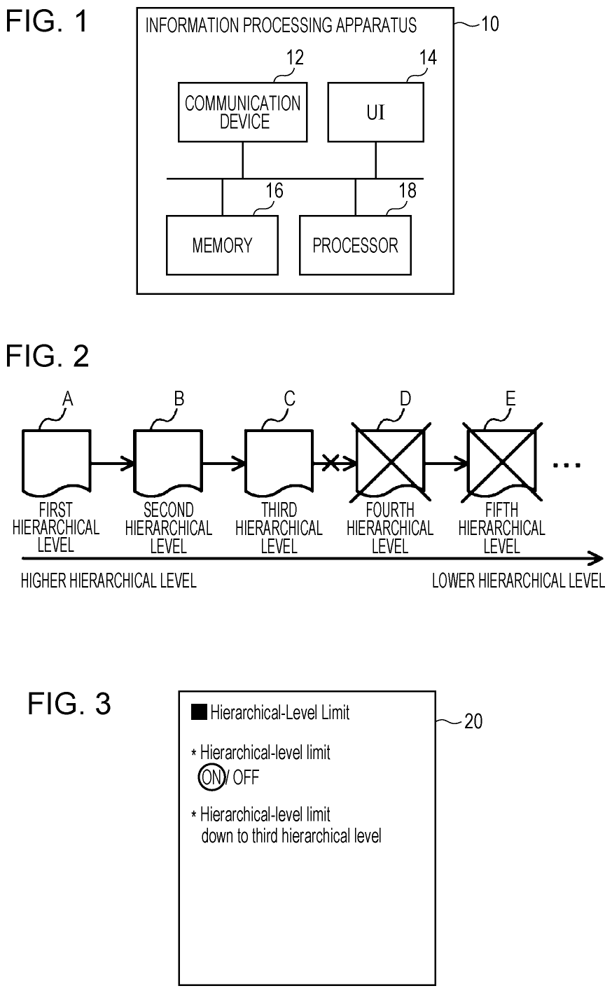

Referring to FIG. 1, an information processing apparatus 10 according to the present exemplary embodiment will be described. FIG. 1 illustrates an exemplary configuration of the information processing apparatus 10 according to the present exemplary embodiment.

The information processing apparatus 10 is, for example, a personal computer (hereinafter referred to as a “PC”), a tablet PC, a smartphone, a wearable device (for example, augmented reality (AR) glasses, virtual reality (VR) glasses, or a bearable device), a cellular phone, or a server.

In the present exemplary embodiment, a hierarchical structure of folders is used to manage files. In this case, the information processing apparatus 10 prohibits creation of a folder belonging to a hierarchical level lower than a specific hierarchical level.

A file is, for example, data or programs. Examples of data include image data, movie data, audio data (for example, voice data and music data), text data, document data, and a combination of at least two of these types of data.

A folder is where files are stored. A folder may be referred to as a directory. Even after creation of a folder, the folder does not necessarily store files actually.

For example, a file system or a database is used to construct a hierarchical structure of folders. A hierarchical structure may be referred to as a tree structure.

Files may be stored in the information processing apparatus 10, or may be stored in an apparatus (for example, a file server) other than the information processing apparatus 10. For example, folders may be created in the information processing apparatus 10 to construct a file system or a database, and files may be stored in the information processing apparatus 10. Alternatively, folders may be created in an apparatus other than the information processing apparatus 10 to construct a file system or a database, and files may be stored in the apparatus other than the information processing apparatus 10. In the case where folders are created in an apparatus other than the information processing apparatus 10, the information processing apparatus 10 communicates with the apparatus, and prohibits creation of folders belonging to hierarchical levels lower than the specific hierarchical level. The communication is wired communication or wireless communication.

For example, in the description below, assume that folders are created in the information processing apparatus 10 and that files are stored in the folders created in the information processing apparatus 10.

As illustrated in FIG. 1, the information processing apparatus 10 includes, for example, a communication device 12, a user interface (UI) 14, a memory 16, and a processor 18.

The communication device 12 is a communication interface having a communication chip, a communication circuit, or the like, and has a function of transmitting information to other apparatuses and a function of receiving information from other apparatuses. The communication device 12 may have a wireless communication function or may have a wired communication function.

The UI 14, which is a user interface, includes a display and at least one operation device. Examples of a display include a liquid-crystal display or an electro-luminescence (EL) display. Examples of an operation device include a keyboard, a mouse, input keys, and an operation panel. The UI 14 may be a UI such as a touch panel serving as both a display and an input device.

The memory 16 is a device in which one or more storage areas for storing various information are formed. The memory 16 is, for example, a hard disk drive, various types of memory (for example, a random-access memory (RAM) or a dynamic random access memory (DRAM), and a read-only memory (ROM)), a different storage device (for example, an optical disk), or a combination of at least two of these types of devices. The information processing apparatus 10 includes one or more memories 16. For example, files are stored in the memories 16.

The processor 18 controls operations of the units of the information processing apparatus 10. The processor 18 may have a memory.

For example, the processor 18 performs processes, such as creating a folder, deleting a folder, moving a folder, storing a file in a folder, deleting a file, and moving a file between folders.

In the case where a hierarchical structure of folders is used to manage files, the processor 18 prohibits creation of a folder belonging to a hierarchical level lower than the specific hierarchical level. For example, even when a user transmits an instruction to create a folder belonging to a hierarchical level lower than the specific hierarchical level, the processor 18 does not create a folder belonging to the hierarchical level lower than the specific hierarchical level. The processor 18 does not necessarily create a folder, or may create a folder in the specific hierarchical level or its higher hierarchical level, not in the hierarchical level lower than the specific hierarchical level. The specific hierarchical level may be determined by a user or an administrator (for example, a person who has permission for setting), or may be determined automatically without an action of a user or an administrator. When a specific condition is satisfied, the processor 18 may prohibit creation of a folder belonging to a hierarchical level lower than the specific hierarchical level.

Embodiment examples according to the present exemplary embodiment will be described in detail below.

### First Embodiment Example

A first embodiment example will be described below.

FIG. 2 illustrates an exemplary hierarchical structure of folders. FIG. 2 illustrates the first to fifth hierarchical levels. One or more folders belong to each hierarchical level.

In the example illustrated in FIG. 2, folder A is a folder in the first hierarchical level; folder B is a folder in the second hierarchical level, and is included in folder A; folder C is a folder in the third hierarchical level, and is included in folder B; folder D is a folder in the fourth hierarchical level, and is included in folder C; folder E is a folder in the fifth hierarchical level, and is included in folder D. Each folder may store files, or does not necessarily store files.

In the example illustrated in FIG. 2, in each hierarchical level, one folder is created. Alternatively, multiple folders may be created. For example, multiple folders belonging to the second hierarchical level may be created, and may be included in folder A in the first hierarchical level. A different folder which is other than folder A and which belongs to the first hierarchical level may be created, and may include a folder belonging to the second hierarchical level. Multiple folders belonging to the second hierarchical level may be created, and some of the folders may be included in folder A and the others may be included in a folder, which is other than folder A, in the first hierarchical level. The same is true for the other hierarchical levels.

For example, the specific hierarchical level is the third hierarchical level. In this case, the processor 18 prohibits creation of a folder belonging to a hierarchical level lower than the third hierarchical level (that is, a folder belonging to the fourth hierarchical level or its lower level). In the example illustrated in FIG. 2, the processor 18 prohibits creation of folders D and E and a folder belonging to a hierarchical level lower than those of folders D and E. For example, even when a user uses the UI 14 to transmit an instruction to create folder D in the fourth hierarchical level which is included in folder C, the processor 18 does not create folder D.

FIG. 3 illustrates an exemplary setting screen 20. The setting screen 20 is a screen for setting a limit for creation of a folder. For example, in response to a user's instruction to display the setting screen 20, the setting screen 20 is displayed on a display of the UI 14. A user or an administrator may set whether there is a limit for creation of a folder, and the specific hierarchical level on the setting screen 20.

When a hierarchical-level limit is set to “ON” on the setting screen 20, creation of a folder belonging to a hierarchical level lower than the specific hierarchical level is prohibited. In the example illustrated in FIG. 3, “third hierarchical level” is set as the specific hierarchical level. When the hierarchical-level limit is set to “OFF”, creation of a folder is not prohibited.

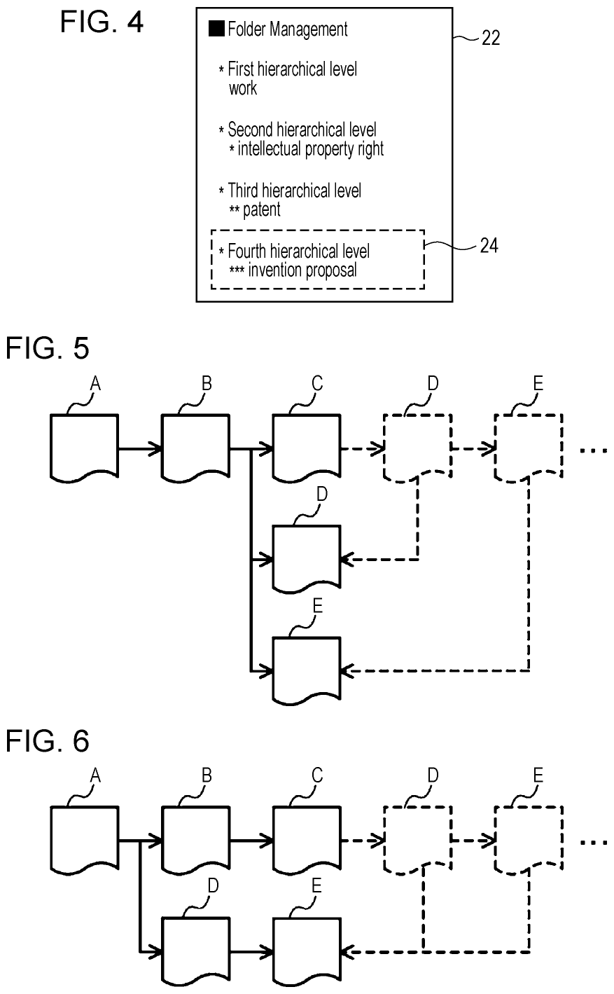

FIG. 4 illustrates an exemplary management screen 22. The management screen 22 is a screen for managing folders. For example, in response to a user's instruction to display the management screen 22, the management screen 22 is displayed on the display of the UI 14. The user may, for example, create a folder, change the name of a folder, and delete a folder on the management screen 22.

For example, folder A belonging to the first hierarchical level is created as a folder related to work; folder B belonging to the second hierarchical level is created as a folder related to intellectual property right; folder C belonging to the third hierarchical level is created as a folder related to patent.

Assume the case in which a user is to create a folder (for example, folder D) belonging to the fourth hierarchical level lower than the third hierarchical level which is the specific hierarchical level (for example, a user inputs the name of a folder belonging to the fourth hierarchical level on the management screen 22, and transmits an instruction to create the folder). In this case, as indicated by using reference numeral 24, even when the processor 18 receives the creation instruction, the processor 18 does not create the folder belonging to the fourth hierarchical level. The processor 18 does not necessarily receive the creation instruction. Also in this case, the folder belonging to the fourth hierarchical level is not created.

The processor 18 may notify the user that creation of a folder belonging to a hierarchical level lower than the third hierarchical level is not allowed. The processor 18 may cause the display of the UI 14 to display a message indicating that creation of a folder belonging to a hierarchical level lower than the third hierarchical level is not allowed, or may produce a voice, in which the message is delivered, from a speaker.

In the case where a user is to create a folder belonging to a hierarchical level lower than the specific hierarchical level, the processor 18 may urge the user to use a folder belonging to a higher hierarchical level. For example, the processor 18 urges the user to store a file in a folder belonging to a recommended higher hierarchical level. The recommended hierarchical level is the hierarchical level in which the folder, belonging to a hierarchical level lower than the specific hierarchical level, would be included if the folder were created. The recommended hierarchical level may be the specific hierarchical level, or may be a hierarchical level higher than the specific hierarchical level. For example, the recommended hierarchical level may be predetermined, and may be changed by a user or an administrator.

For example, when a user transmits, on the management screen 22, an instruction to create folder D (for example, folder D whose name is “invention proposal”) belonging to the fourth hierarchical level, the processor 18 urges the user to use a folder belonging to a hierarchical level higher than the fourth hierarchical level. The processor 18 urges the user to use at least one of the folders, folders A, B, and C, in which folder D will be included if folder D is created. The processor 18 may urge the user to use folder C belonging to the third hierarchical level which is the specific hierarchical level, or may urge the user to use folder A or B belonging to a recommended hierarchical level higher than the third hierarchical level. For example, when folder C is the recommended folder, the processor 18 may cause the display of the UI 14 to display a message that “Store the file in folder C whose name is ‘Patent’.” or may produce a voice, in which the message is delivered, from a speaker.

When a user is to create a folder belonging to a hierarchical level lower than the specific hierarchical level, the processor 18 may ask the user whether the prohibition of creation of a folder, belonging to a hierarchical level lower than the specific hierarchical level, is to be canceled. For example, when the user transmits, on the management screen 22, an instruction to create folder D belonging to the fourth hierarchical level, the processor 18 may cause the display of the UI 14 to display a message that the prohibition is to be canceled, or may produce a voice, in which the message is delivered, from a speaker. When a user or an administrator sets the hierarchical-level limit to “OFF” on the setting screen 20, the prohibition of creation of a folder, belonging to a hierarchical level lower than the specific hierarchical level (for example, a folder belonging to the fourth hierarchical level), is canceled, and the user may create the folder.

### Second Embodiment Example

A second embodiment example will be described below.

Assume the case in which folders, belonging to a hierarchical level lower than the specific hierarchical level (for example, the third hierarchical level), have been already created before setting of prohibition of creation of a folder belonging to a hierarchical level lower than the specific hierarchical level. In this case, when creation of a folder belonging to a hierarchical level lower than the specific hierarchical level is prohibited after creation of the folders, the processor 18 causes the folders, belonging to hierarchical levels lower than the specific hierarchical level, to belong to a higher hierarchical level.

Referring to FIG. 5, the second embodiment example will be described in detail. FIG. 5 illustrates a hierarchical structure of folders.

For example, before setting of prohibition of creation of a folder belonging to a hierarchical level lower than the third hierarchical level, folder D, which is included in folder C and which belongs to the fourth hierarchical level, and folder E, which is included in folder D and which belongs to the fifth hierarchical level, have been already created.

In this state, in the case where creation of a folder belonging to a hierarchical level lower than the third hierarchical level is prohibited, the processor 18 causes folders D and E to belong to the specific hierarchical level (for example, the third hierarchical level) or its higher hierarchical level. When folder D stores a file, folder D belongs to the specific hierarchical level or its higher hierarchical level while storing the file. The same is true for folder E.

For example, as illustrated in FIG. 5, the processor 18 causes folders D and E to belong to the third hierarchical level and to be included in folder B belonging to the second hierarchical level. In this case, folders C, D, and E belong to the third hierarchical level. The processor 18 may cause folders D and E to belong to the second hierarchical level and to be included in folder A belonging to the first hierarchical level. In FIG. 5, broken lines represent the state before change of the attribute; solid lines represent the state after change of the attribute.

The processor 18 may store, for example, information about the change of hierarchical level, which enables recovery to the hierarchy before the change of hierarchical level. For example, after folders D and E are caused to belong to the first hierarchical level or the second hierarchical level (that is, after the hierarchical levels of folders D and E are changed), the processor 18 may cause folders D and E to belong to the respective original hierarchical levels when prohibition of creation of a folder belonging to a hierarchical level lower than the third hierarchical level is canceled. That is, the processor 18 may cause folder D to belong to the fourth hierarchical level and to be included in folder C, and may cause folder E to belong to the fifth hierarchical level and to be included in folder D. As a matter of course, the processor 18 may maintain the change of hierarchical level of folders D and E.

### Third Embodiment Example

A third embodiment example will be described below.

Assume the case in which folders, belonging to hierarchical levels lower than the specific hierarchical level (for example, the third hierarchical level), have been already created before setting of prohibition of creation of a folder belonging to a hierarchical level lower than the specific hierarchical level. In this case, when creation of a folder belonging to a hierarchical level lower than the specific hierarchical level is prohibited after creation of the folders, the processor 18 causes the folders, belonging to the hierarchical levels lower than the specific hierarchical level, to belong to a higher hierarchical level, while maintaining their hierarchical structure.

Referring to FIG. 6, the third embodiment example will be described in detail. FIG. 6 illustrates a hierarchical structure of folders.

For example, before setting of prohibition of creation of a folder belonging to a hierarchical level lower than the third hierarchical level, folder D, which is included in folder C and which belongs to the fourth hierarchical level, and folder E, which is included in folder D and which belongs to the fifth hierarchical level, have been already created.

In this state, when creation of a folder belonging to a hierarchical level lower than the third hierarchical level is prohibited, the processor 18 causes folders D and E to belong to a higher hierarchical level, while maintaining their hierarchical structure. When folder D stores a file, folder D is caused to belong to a higher hierarchical level while storing the file. The same is true for folder E.

For example, as illustrated in FIG. 6, the processor 18 causes folder D to belong to the second hierarchical level and to be included in folder A belonging to the first hierarchical level, and causes folder E to belong to the third hierarchical level and to be included in folder D belonging to the second hierarchical level. Thus, while the hierarchical structure, in which folder E belongs to a hierarchical level lower than that of folder D and is included in folder D, is maintained, the hierarchical level of folders D and E is changed.

When prohibition of creation of a folder belonging to a hierarchical level lower than the third hierarchical level is canceled, the processor 18 may cause folders D and E to belong to their original hierarchical levels, or may maintain the change of hierarchical level of folders D and E.

### Fourth Embodiment Example

A fourth embodiment example will be described below.

Assume the case in which folders, belonging to a hierarchical level lower than the specific hierarchical level (for example, the third hierarchical level), have been already created before setting of prohibition of creation of a folder belonging to a hierarchical level lower than the specific hierarchical level. In this case, when creation of a folder belonging to a hierarchical level lower than the specific hierarchical level is prohibited after creation of the folders, the processor 18 stores, in a folder belonging to a higher hierarchy, the files stored in the folders belonging to hierarchical levels lower than the specific hierarchical level.

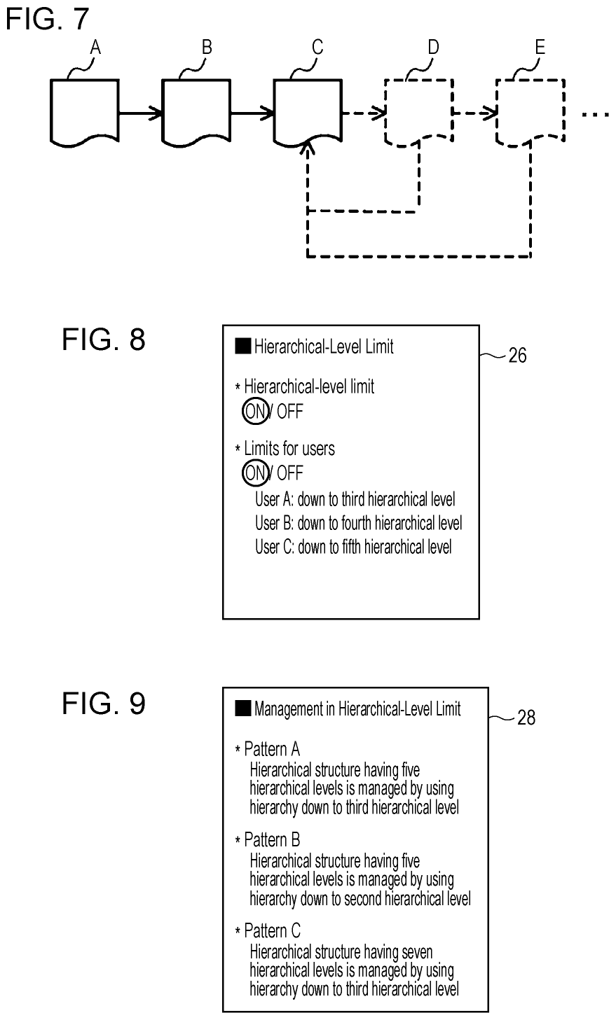

Referring to FIG. 7, the fourth embodiment example will be described in detail. FIG. 7 illustrates a hierarchical structure of folders.

For example, before setting of prohibition of creation of a folder belonging to a hierarchical level lower than the third hierarchical level, folder D, which is included in folder C and which belongs to the fourth hierarchical level, and folder E, which is included in folder D and which belongs to the fifth hierarchical level, have been already created.

In this state, when creation of a folder belonging to a hierarchical level lower than the third hierarchical level is prohibited, the processor 18 stores, in a folder belonging to a higher hierarchical level, the files stored in folders D and E. The higher hierarchical level may be the specific hierarchical level, or may be a hierarchical level higher than the specific hierarchical level. In the example in FIG. 7, the files stored in folders D and E are stored in folder C belonging to the third hierarchical level which is the specific hierarchical level. The processor 18 may delete folders D and E, or does not necessarily delete folders D and E.

When prohibition of creation of a folder belonging to a hierarchical level lower than the third hierarchical level is canceled, the processor 18 may store the files, which were originally stored in folders D and E and which are stored in folder C, in their original folders, folders D and E. When folders D and E have been deleted, the processor 18 may create folders D and E and may store the files in their original folders, folders D and E.

The files stored in folders D and E may be stored in folder A or folder B.

### Fifth Embodiment Example

A fifth embodiment example will be described below.

The processor 18 prohibits, on a user-by-user basis, creation of a folder belonging to a hierarchical level lower than the specific hierarchical level.

FIG. 8 illustrates a setting screen 26 according to the fifth embodiment example. A user or an administrator may prohibit, on a user-by-user basis, creation of a folder belonging to a hierarchical level lower than the specific hierarchical level, on the setting screen 26. For example, the specific hierarchical level may be changed depending on each user. For groups, each of which one or more users belong to, creation of a folder belonging to a hierarchical level lower than the specific hierarchical level may be prohibited on a group-by-group basis.

In the example illustrated in FIG. 8, the specific hierarchical level for user A is the third hierarchical level; the specific hierarchical level for user B is the fourth hierarchical level; the specific hierarchical level for user C is the fifth hierarchical level. Information indicating this setting is stored in the memory 16 of the information processing apparatus 10. For example, for each user, information for identifying the user (for example, their user ID, account information, or name) and information indicating the specific hierarchical level are stored in the memory 16 in association with each other. The processor 18 refers to the information to change the specific hierarchical level depending on each user, and prohibits or does not prohibit creation of a folder.

For example, when user A logs in the information processing apparatus 10 by using their own account information, the processor 18 permits user A to create a folder down to the third hierarchical level, and prohibits user A from creating a folder belonging to the fourth hierarchical level or its lower hierarchical levels. The same is true for the other users.

The processor 18 may permit a user to access folders belonging to hierarchical levels lower than the specific hierarchical level and the files stored in the folders. Thus, user A may access folders belonging to the fourth hierarchical level and its lower hierarchical levels and may access the files stored in the folders. The same is true for the other users.

The processor 18 may change the specific hierarchical level in accordance with a user's attribute (for example, their permission, skill, status, or job title).

FIG. 9 illustrates a different setting screen 28. The example in FIG. 9 describes a hierarchical structure according to pattern A (the pattern in which a hierarchical structure having five actual hierarchical levels is managed by using the hierarchy down to the third hierarchical level), a hierarchical structure according to pattern B (the pattern in which a hierarchical structure having five actual hierarchical levels is managed by using the hierarchy down to the second hierarchical level), and a hierarchical structure according to pattern C (the pattern in which a hierarchical structure having seven actual hierarchical levels is managed by using the hierarchy down to the third hierarchical level). For example, when a user or an administrator specifies pattern A, creation of a folder belonging to a hierarchical level lower than the third hierarchical level is prohibited. The processor 18 manages folders and files by using the hierarchical structure down to the third hierarchical level. The same is through for the other patterns.

The processor 18 may prohibit, for each folder, creation of a folder belonging to a hierarchical level lower than the specific hierarchical level. For example, for folders associated with work (for example, folders for work), the processor 18 may prohibit creation of a folder belonging to a hierarchical level lower than the specific hierarchical level. For folders associated with pleasure (for example, folders for pleasure), the processor 18 may prohibit creation of a folder belonging to a hierarchical level lower than the specific hierarchical level.

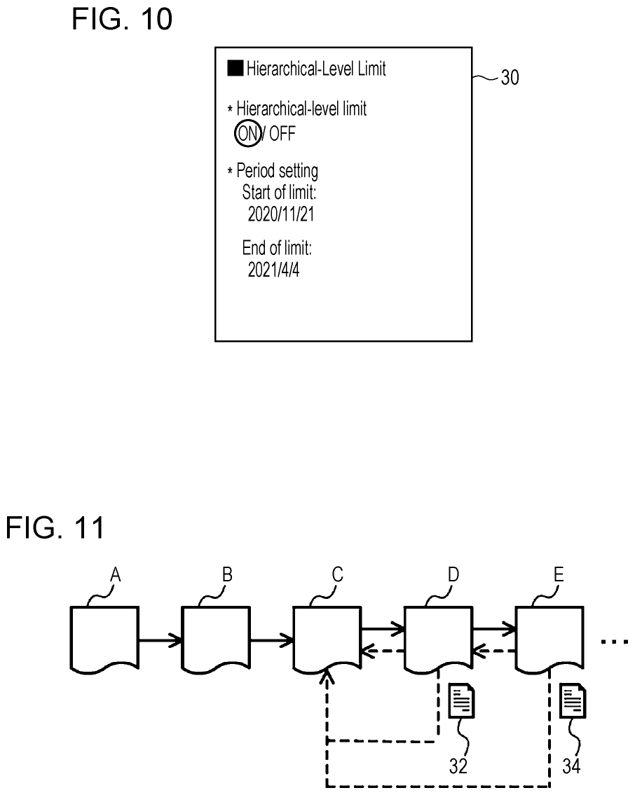

The processor 18 may determine a period in which creation of a folder belonging to a hierarchical level lower than the specific hierarchical level is prohibited. Referring to FIG. 10, this process will be described. FIG. 10 illustrates a setting screen 30. A user or an administrator may set the time (for example, the date or date and time) of start of the limit and the time (for example, the date or date and time) of end of the limit on the setting screen 30. The period between the time of start of the limit and the time of end of the limit is a period in which creation of a folder belonging to a hierarchical level lower than the specific hierarchical level is prohibited. After setting of the period, the processor 18 prohibits creation of a folder belonging to a hierarchical level lower than the specific hierarchical level during the period, and does not prohibit creation of a folder belonging to a hierarchical level lower than the specific hierarchical level out of the period. In the case where the period has not been set, the processor 18 prohibits creation of a folder belonging to a hierarchical level lower than the specific hierarchical level while the prohibition is set (that is, as long as the prohibition is not canceled).

### Sixth Embodiment Example

A sixth embodiment example will be described below.

The processor 18 may change folders of a file in accordance with the frequency of use of the file. The frequency of use of a file is, for example, the frequency with which the file was operated (for example, the number of operations or the number of operations per unit period) or the frequency of access to the file (for example, the access count or the access count per unit period). Examples of operations on a file include editing the file, opening the file, and copying the file. Referring to FIG. 11, this process will be described in detail. FIG. 11 illustrates a hierarchical structure of folders.

For example, when the frequency of use of a file is equal to or higher than a threshold, the processor 18 moves the file to a folder higher than the folder storing the file. Thus, the processor 18 stores the file in the higher folder, and does not store the file in the folder which originally stored the file. The higher folder may be a folder belonging to the next higher hierarchical level of the folder which originally stored the file, or may be a folder belonging to a further higher hierarchical level. The higher folder may be specified by a user. As a matter of course, the processor 18 may store a copy of the file in the higher folder while storing the file in the original folder.

For example, assume the case in which a file is stored in a folder, belonging to a hierarchical level lower than the specific hierarchical level, before setting of prohibition of creation of a folder belonging to a hierarchical level lower than the specific hierarchical level. Then, when prohibition of the creation is set, if the frequency of use of the stored file is equal to or higher than the threshold, the processor 18 stores the file in a folder belonging to the specific hierarchical level or its higher hierarchical level.

For example, when the frequency of use of a file 32 stored in folder D is equal to or higher than the threshold (for example, when the access count per month is equal to or greater than 20), the processor 18 stores the file 32 in folder C belonging to the third hierarchical level which is the specific hierarchical level. The processor 18 moves the file 32 from folder D to folder C. Thus, the processor 18 stores the file 32 in folder C, and does not store the file 32 in folder D. As a matter of course, the processor 18 may store a copy of the file 32 in folder C while storing the file 32 in folder D.

In the state in which the file 32 is stored in folder C (that is, after the file 32 is moved to folder C), when the frequency of use of the file 32 is equal to or higher than the threshold, the processor 18 moves the file 32 from folder C to folder B. Thus, the processor 18 stores the file 32 in folder B, and does not store the file 32 in folder C. Thus, a file is stored in a folder belonging to a higher hierarchical level by changing the hierarchical level gradually in accordance with the frequency of use of the file. The processor 18 may store a copy of the file 32 in folder B while storing the file 32 in folder C.

Similarly, when the frequency of use of a file 34 stored in folder E is equal to or higher than the threshold, the processor 18 stores the file 34 in folder C belonging to the third hierarchical level. The processor 18 may move the file 34 to folder D belonging to the next higher hierarchical level of that of folder E, and may thus store the file 34 in folder D.

Similarly, when the frequency of use of each file stored in folders B and C is equal to or higher than the threshold, the processor 18 stores the file in a higher-level folder. For example, when the frequency of use of a file stored in folder C is equal to or higher than the threshold, the processor 18 moves the file from folder C to folder B, and stores the file in folder B.

A different threshold may be set for each hierarchical level. For example, the threshold for moving a file from a folder belonging to the fourth hierarchical level (for example, folder D) to a folder belonging to the third hierarchical level (for example, folder C) may be different from that for moving a file from a folder belonging to the third hierarchical level (for example, folder C) to a folder belonging to the second hierarchical level (for example, folder B). For example, the latter may be higher than the former, or these values may be determined by a user.

The processor 18 may move a file to a folder, belonging to a hierarchical level lower than that of the folder storing the file, in accordance with the frequency of use of the file. For example, when the frequency of use of a file is equal to or less than a threshold for moving a file to a folder belonging to a lower hierarchical level, the processor 18 moves the file to a folder belonging to a hierarchical level lower than that of the folder storing the file. For example, when the frequency of use of a file stored in folder B is equal to or less than the threshold, the processor 18 moves the file to folder C and stores the file in folder C.

The processor 18 may change the hierarchical level, to which a folder belongs, in accordance with the frequency of use of the folder. Examples of the frequency of use of a folder include the frequency of operations on the folder, the frequency of access to the folder, the frequency of operations on files stored in the folder, and the frequency of access to files stored in the folder. When a folder stores multiple files, the total of the frequencies of use of the files may serve as the frequency of use of the folder.

For example, when the frequency of use of folder D belonging to the fourth hierarchical level is equal to or higher than a threshold, the processor 18 causes folder D to belong to the third hierarchical level which is the next higher hierarchical level. In this case, folders C and D are included in folder B as folders belonging to the third hierarchical level. In the state in which folder C belongs to the third hierarchical level, when the frequency of use of folder C is equal to or higher than the threshold, the processor 18 causes folder C to belong to the second hierarchical level. Thus, a folder may belong to a higher hierarchical level in accordance with its frequency of use.

The frequency of use of a file may be a frequency to which weighting has been applied in accordance with the content of operations on the file. For example, weighting factors are determined in accordance with operations, such as editing a file, opening a file, and copying a file. The processor 18 performs weighting by using a factor determined in accordance with the content of an operation on a file, and calculates the frequency of use of the file. For example, the factor for an operation of editing a file is greater than the factor for an operation of opening a file. Editing a file makes its frequency of use higher than the case in which the file is opened.

Similarly, the frequency of use of a folder may be a frequency to which weighting has been applied in accordance with the content of operations on the folder.

The processor 18 may change the move destination folder in accordance with the content of an operation on a file. For example, when a second file is opened while a first file is opened, the processor 18 moves the second file to the folder storing the first file.

The processor 18 may perform one of the following processes in accordance with the content of an operation on a file: storing a copy of the file in the move destination folder while storing the file in the original folder; moving the file to the move destination folder without storage of the file in the original folder.

When a file is moved from the original folder to a different folder, or when a copy of a file is stored in the move destination folder, the processor 18 may notify a user or an administrator of a message indicating this. When the user or the administrator permits the move or storage, the processor 18 may move the file to the different folder or may store a copy of the file in the different folder. When the user or the administrator does not permit the move or storage, the processor 18 does not move the file to the different folder, or does not store a copy of the file in the different folder.

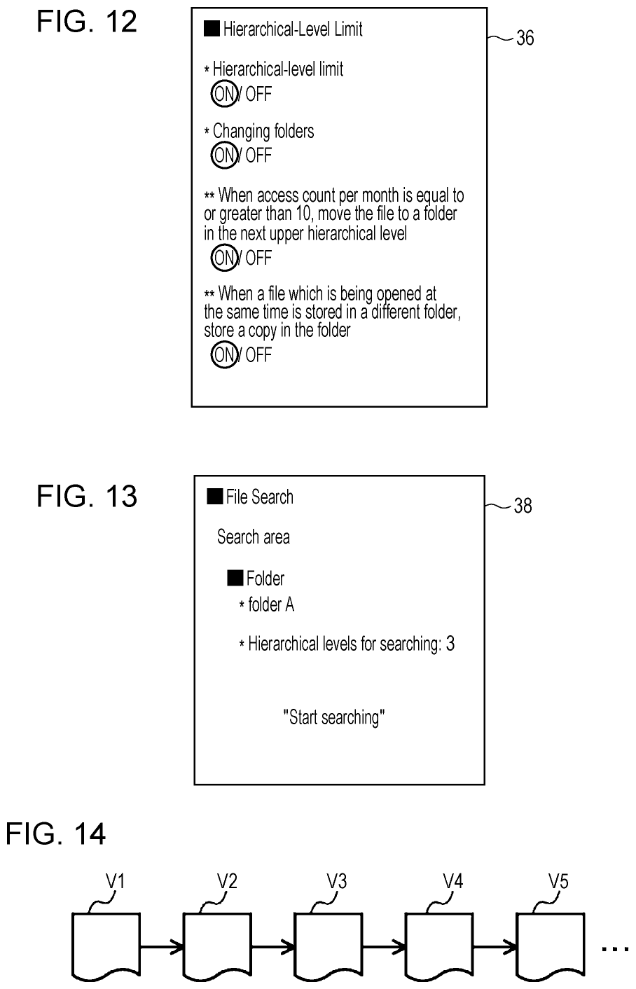

FIG. 12 illustrates a setting screen 36 according to the sixth embodiment example. Conditions for moving a file are set on the setting screen 36. For example, a condition of, when the access count per month is equal to or greater than ten, moving the file to a folder belonging to the next higher hierarchical level, and a condition of, when a file which is being opened at the same time is stored in a different folder, storing a copy in the different folder may be set on the setting screen 36.

### Seventh Embodiment Example

A seventh embodiment example will be described below.

In a search of a file stored in a folder, the processor 18 searches, for the file, hierarchical levels higher than a specified hierarchical level. A higher hierarchical level searched for a file may be the specific hierarchical level or may be a different hierarchical level.

FIG. 13 illustrates a setting screen 38 for searching.

A search area may be specified on the setting screen 38. In the example illustrated in FIG. 13, folder A and the third hierarchical level are specified. This specification is made by a user or an administrator. The processor 18 searches, for a file, folder A, and folders B and C, which are included in folder A and which belong to the third hierarchical level and its higher hierarchical levels, and does not search folders D and E for the file.

### Eighth Embodiment Example

An eighth embodiment example will be described below.

The processor 18 changes the specific hierarchical level in accordance with a user who has determined the hierarchical structure of folders. The concept of the user in the eighth embodiment example encompasses a person who has permission to determine a hierarchical structure, such as an administrator.

For example, information indicating a different hierarchical structure of folders, which was determined in the past by a user who has determined the hierarchical structure of files constructed in the information processing apparatus 10, is stored, for example, in a memory. The processor 18 determines the specific hierarchical level in the hierarchical structure of files, which is constructed in the information processing apparatus 10, in accordance with the feature of the different hierarchical structure of files which was determined in the past. For example, when the feature indicates that the created hierarchy has a large number of hierarchical levels, the processor 18 does not prohibit creation of a folder belonging to a lower hierarchical level, compared with the case in which the feature indicates that the created hierarchy has a small number of hierarchical levels.

For example, the hierarchical structure of folders, which was created by user A in the past, has three hierarchical levels; the hierarchical structure of folders, which was created by user B in the past, has five hierarchical levels. When the hierarchical structure of folders in the information processing apparatus 10 was constructed by user A, the specific hierarchical level is set to the third hierarchical level, and the processor 18 prohibits creation of a folder belonging to a hierarchical level lower than the third hierarchical level. When the hierarchical structure of folders in the information processing apparatus 10 was constructed by user B, the specific hierarchical level is set to the fifth hierarchical level, and the processor 18 prohibits creation of a folder belonging to a hierarchical level lower than the fifth hierarchical level.

In the embodiment examples described above, a folder, which is to store a file, may be determined in accordance with the type of the file. For example, a movie file may be stored in a folder for movie. A music file may be stored in a folder for music.

### Other Exemplary Embodiments

Other exemplary embodiments will be described below. In the embodiment examples described above, folders and files are managed. In a different exemplary embodiment, playback of movies and music may be managed. For example, playback of movies will be described.

FIG. 14 illustrates the playback order of movies. For example, movie V1, movie V2 associated with movie V1, movie V3 associated with movie V2, movie V4 associated with movie V3, and movie V5 associated with movie V4 are played back in this sequence.

For example, in response to a user's instruction to play back movie V1, the processor 18 plays back movie V1. When playback of movie V1 ends, the processor 18 plays back movie V2, which is the next movie, automatically. The same is true for movie V3 and its subsequent movies.

Description will be made in association with the hierarchy. Movie V1 belongs to the first hierarchical level; movie V2 belongs to the second hierarchical level; movie V3 belongs to the third hierarchical level; movie V4 belongs to the fourth hierarchical level; movie V5 belongs to the fifth hierarchical level.

For example, when playback of a movie belonging to a hierarchical level lower than the third hierarchical level is prohibited, the processor 18 plays back movies V1, V2, and V3 in this sequence. After playback of movies V1, V2, and V3, the processor 18 does not play back movies V4 and V5 belonging to the fourth hierarchical level and its lower hierarchical levels. Since movie V1 is specified by a user and movie V2 is associated with movie V1, movies V1 and V2 are presumed to be movies the user is interested in. The same is true for movie V3. Movies V4 and V5 are presumed to have low relevance to movie V1. Therefore, it is presumed that the user is not interested in movies V4 and V5. Movies V4 and V5 are not played back after playback of movies V1, V2, and V3. Thus, playback of movies, in which the user is presumed not to be interested, may be prevented. The specific hierarchical level may be specified by the user. The same is true for playback of music and display of images.

Other than movies and music, link destinations, specified by using addresses such as uniform resource locators (URLs), may be managed in Web pages. For example, the link destinations included in a Web page corresponding to the first hierarchical level are Web pages corresponding to the second hierarchical level; the link destinations included in a Web page corresponding to the second hierarchical level are Web pages corresponding to the third hierarchical level. The same is true for its subsequent Web pages. In this case, the processor 18 may prohibit access to a Web page corresponding to the specific hierarchical level (for example, the third hierarchical level). For example, moving from a Web page corresponding to the first hierarchical level to a Web page corresponding to the second hierarchical level is permitted. Moving from the Web page corresponding to the second hierarchical level to a Web page corresponding to the third hierarchical level after the previous moving is prohibited.

The functions of the units of the information processing apparatus 10 are implemented, for example, through collaboration between hardware and software. For example, the processor of the information processing apparatus 10 reads, for execution, programs stored in a memory of the information processing apparatus 10. Thus, the functions of the devices are implemented. The programs are stored in a memory through a recording medium, such as a compact disk (CD) or a digital versatile disk (DVD), or through a communication path such as a network.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
when a hierarchical structure of folders is used to manage a file, prohibit creation of a folder belonging to a hierarchical level lower than a specific hierarchical level.

2. The information processing apparatus according to claim 1,
wherein the specific hierarchical level is determined by a user.

3. The information processing apparatus according to claim 1,
wherein the processor is further configured to:
when a user is to create a folder belonging to a hierarchical level lower than the specific hierarchical level, urge the user to use a folder belonging to a higher hierarchical level.

4. The information processing apparatus according to claim 1,
wherein the processor is further configured to:
when a user is to create a folder belonging to a hierarchical level lower than the specific hierarchical level, ask the user whether prohibition of creation of a folder belonging to a hierarchical level lower than the specific hierarchical level is to be canceled.

5. The information processing apparatus according to claim 2,
wherein the processor is further configure to:
when a user is to create a folder belonging to a hierarchical level lower than the specific hierarchical level, ask the user whether prohibition of creation of a folder belonging to a hierarchical level lower than the specific hierarchical level is to be canceled.

6. The information processing apparatus according to claim 1,
wherein the processor is configure to:
after a folder belonging to a hierarchical level lower than the specific hierarchical level has been already created, when creation of a folder belonging to a hierarchical level lower than the specific hierarchical level is prohibited, cause the created folder to belong to a higher hierarchical level.

7. The information processing apparatus according to claim 2,
wherein the processor is configure to:
after a folder belonging to a hierarchical level lower than the specific hierarchical level has been already created, when creation of a folder belonging to a hierarchical level lower than the specific hierarchical level is prohibited, cause the created folder to belong to a higher hierarchical level.

8. The information processing apparatus according to claim 3,
wherein the processor is configure to:
after a folder belonging to a hierarchical level lower than the specific hierarchical level has been already created, when creation of a folder belonging to a hierarchical level lower than the specific hierarchical level is prohibited, cause the created folder to belong to a higher hierarchical level.

9. The information processing apparatus according to claim 1,
wherein the processor is configure to:
after folders belonging to a hierarchical level or hierarchical levels lower than the specific hierarchical level have been already created, when creation of a folder belonging to a hierarchical level lower than the specific hierarchical level is prohibited, cause the created folders to belong to a higher hierarchical level or higher hierarchical levels while maintaining a hierarchical structure of the created folders.

10. The information processing apparatus according to claim 1,
wherein the processor is configure to:
after a folder belonging to a hierarchical level lower than the specific hierarchical level has been already created and has stored a file, when creation of a folder belonging to a hierarchical level lower than the specific hierarchical level is prohibited, store the file in a folder belonging to a higher hierarchical level.

11. The information processing apparatus according to claim 1,
wherein the processor is configured to:
prohibit, on a user-by-user basis, creation of a folder belonging to a hierarchical level lower than the specific hierarchical level.

12. The information processing apparatus according to claim 1,
wherein the processor is configured to:
prohibit, on a folder-by-folder basis, creation of a folder belonging to a hierarchical level lower than the specific hierarchical level.

13. The information processing apparatus according to claim 1,
wherein the processor is configured to:
determine a period of prohibition of creation of a folder belonging to a hierarchical level lower than the specific hierarchical level.

14. The information processing apparatus according to claim 1,
wherein the processor is configured to:
change folders of a file in accordance with a frequency of use of the file, the file being stored in either one of the folders.

15. The information processing apparatus according to claim 1,
wherein the processor is configured to:
change a hierarchical level of a folder in accordance with a frequency of use of the folder.

16. The information processing apparatus according to claim 14,
wherein the frequency of use is a frequency to which weighting has been applied in accordance with content of an operation.

17. The information processing apparatus according to claim 1,
wherein the processor is further configured to:
search higher hierarchical levels for a file, the higher hierarchical levels including a specified hierarchical level and hierarchical levels higher than the specified hierarchical level.

18. The information processing apparatus according to claim 1,
wherein the processor is configured to:
change the specific hierarchical level in accordance with a user who has determined the hierarchical structure of folders.

19. A non-transitory computer readable medium storing a program causing a computer to execute a process comprising:
when a hierarchical structure of folders is used to manage a file, prohibiting creation of a folder belonging to a hierarchical level lower than a specific hierarchical level.

20. An information processing method comprising:
when a hierarchical structure of folders is used to manage a file, prohibiting creation of a folder belonging to a hierarchical level lower than a specific hierarchical level.
